(19) United States
(12) Patent Application Publication
(10) Pub. No.: US 2024/0330046 A1
(43) Pub. Date: Oct. 3, 2024

(54) ADVANCED HARDWARE SCHEDULING USING UNMAPPED-QUEUE DOORBELLS

(71) Applicant: ADVANCED MICRO DEVICES, INC., Santa Clara, CA (US)

(72) Inventors: Alexander Fuad Ashkar, Winter Park, FL (US); Joseph L. Greathouse, Austin, TX (US); Manu Rastogi, Casselberry, FL (US)

(21) Appl. No.: 18/374,837

(22) Filed: Sep. 29, 2023

Related U.S. Application Data
(60) Provisional application No. 63/456,066, filed on Mar. 31, 2023.

(51) Int. Cl. G06F 9/48; G06F 9/50

(52) U.S. Cl. CPC G06F 9/4881; G06F 9/5038; G06F 2209/5021

(57) ABSTRACT

A processing device includes a hardware scheduler, an unmapped queue unit, and command processor, and a plurality of compute units. Responsive to a queue doorbell being an unmapped queue doorbell, the unmapped queue unit is configured to transmit a signal to the hardware scheduler indicating work has been placed into a queue currently unmapped to a hardware queue of the processing device. The hardware scheduler is configured to map the queue to a hardware queue of a plurality of hardware queues at the processing device in response to the signal. The command processor is configured to dispatch the work associated with the mapped queue to one or more compute units of the plurality of compute units.

### BACKGROUND

In an accelerated processing device (APD), such as a graphics processing unit (GPU), hardware scheduling involves managing and scheduling the execution of tasks, or work items, on the APD's processing resources (e.g., cores) using queues. Queues are essential data structures that facilitate the organization, prioritization, and dispatching of tasks to the available hardware resources of the APD. The use of queues in hardware scheduling ensures efficient utilization of APD resources, maximizes parallelism, and optimizes overall performance.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an example processing system in accordance with some implementations.

FIG. 2 is a block diagram of an example processing system for performing hardware scheduling using unmapped software queue doorbells in accordance with some implementations.

FIG. 3 is a block diagram illustrating a detailed view of an unmapped queue unit of the processing system of FIG. 2 in accordance with some implementations.

FIG. 4 and FIG. 5 together are a flow diagram illustrating an example method for detecting work in unmapped software queues and performing hardware scheduling using unmapped software queue doorbells in accordance with some implementations.

FIG. 6 illustrates one example of a plurality of register arrays for recording unmapped software queue doorbells in accordance with some implementations.

### DETAILED DESCRIPTION

Traditionally, a processing device, such as a central processing unit (CPU), directly wrote to the APD's memory-mapped input/output (MMIO) registers to configure the APD. For example, the CPU scheduled work for the APD, such as streams of vertices, texture information, and instructions to process such information, by directly writing work, such as the tasks (kernels) or commands, into the MMIO registers. However, modern APDs are typically driven by firmware-controlled microcontrollers, such as a hardware scheduler and a command processor, at the “front-end” of the graphics and compute pipelines, and move the responsibility of register writes to these front-end microcontrollers. Therefore, the distant CPUs only need to write work packets into memory.

The firmware-controlled microcontrollers of the APD read and process work submitted by devices outside the APD, such as the kernel-mode driver (KMD) or user-mode driver (UMD), that run on a host processing device, such as a central processing unit (CPU). For example, in at least some configurations, such as those implementing a heterogeneous system architecture (HSA), an application submits work (e.g., command packets) to a software queue, which is managed by the CPU or APD driver and is located in the system memory. The CPU or APD driver copies the work from the software queue to a hardware queue associated with the APD and mapped to the software queue by the hardware scheduler. A notification mechanism (referred to herein as a “doorbell”) is typically used to inform the APD, particularly a command processor of the APD, that new tasks are available for processing in the hardware queue. For example, the application or APD driver writes to a memory-mapped doorbell register associated with the hardware queue. Doorbells are special registers that can be accessed by both the CPU and APD. When the doorbell register is written to, an interrupt or a signal is sent to the command processor, indicating that new work is available in the hardware queue. The command processor then schedules tasks for execution on processing units of the APD, such as compute units.

In at least some configurations, an APD is associated with multiple software queues to allow more work to be sent to the APD in parallel. For example, multiple users (such as a web browser and a game) of the APD are able to simultaneously send work to the APD by placing command packets (which include tasks, commands, or operations) for execution on the APD into different software queues. The command packets are processed by the APD by mapping the software queues to hardware queues and scheduling a work item associated with a hardware queue for processing by a hardware resource, such as compute unit, of the APD. However, the APD hardware has a limited number of pipes, each of which has a fixed number of hardware queues. Therefore, the hardware of the APD, such as the command processor, can typically only look at a finite number of hardware queues simultaneously. As such, if there are too many software queues, the hardware scheduler of the APD typically implements one or more time multiplexing techniques when determining which subset of software queues to map to the hardware queues. These time multiplexing techniques map software queues onto hardware queues by multiplexing the software queues onto hardware queues using time slicing.

One technique for time multiplexing the software queues is to map the software queues to the available hardware queues using a round-robin method. In this example, the hardware scheduler spends a certain amount of time looking for work in software queues X-Y, then move to software queues A-B. If there is no work in software queues A-B, this would still cause a delay in handling work submitted to software queues X-Y. With some hardware configurations, the work items in software queues X-Y may even need to be removed from the hardware in order to check for work items in software queues A-B, which results in lower throughput in the hardware. Another technique for time multiplexing the software queues is to request that users (e.g., applications) explicitly inform the hardware scheduler when they put work items into a software queue so that the hardware scheduler can prioritize mapping that software queue to a hardware queue whenever there is work and can disconnect the software queue from a hardware queue when there is no work.

One problem with the first multiplexing technique is that this technique can lead to hardware underutilization. Work items may be placed into unmapped software queues but the “oblivious” hardware scheduler spends time looking for work items in empty software queues. Without being pushed the information of when software queues have work items, an “oblivious” hardware scheduler typically needs to determine which queues to attach and when by one of two options: (1) constantly rolling through the runlist, which is a list of all the hardware queues and locations in memory, every N milliseconds, assuming all of the software queues have work in them; or (2) constantly rolling through the runlist every N milliseconds but check if the software queues have work in them before attaching them. Both options add substantial runtime overhead, which has performance implications for hardware and software. For example, when over-subscribed, a processor can take runtime overheads proportional to the number of processes that are being used. For example, with three processes there may be a 33% slowdown, while with four processes there may be a 50% slowdown for all processes, etc. Even if the second option is employed, there can be relatively high launch latencies when a software queue having a work item is not attached. For example, it may take many milliseconds for the hardware schedule to arrive at a specified queue and check for work. This delay in checking a software queue for work items results in launch latency, which is a critical performance factor for most compute software. For example, going from a 5 microseconds launch latency to a 5 milliseconds launch latency has significant performance implications.

Regarding the second technique, one problem is that this technique requires software to explicitly become involved in the hardware scheduling/multiplexing decisions. For example, the application submitting the work item needs to determine if the software queue associated with the work item is mapped to a hardware queue of the APD and ring a specific doorbell (e.g., write to a specific hardware location) to request that the hardware scheduler map this specific software queue to a hardware queue. This process breaks the interface abstraction by making software directly part of the scheduling decision, which increases the complexity of the software. For example, HSA kernel dispatches are handled by user-space code through a fixed application binary interface (ABI) (e.g., move hardware queue's write pointer, write dispatch packet, ring hardware queue's doorbell). Changing the ABI such that different doorbells are rang based on the hardware scheduling logic breaks the layer of abstraction provided by the ABI and makes such an “explicit messaging” solution difficult to use.

Accordingly, the present disclosure describes implementations of systems and methods for performing hardware scheduling at an APD using unmapped queue doorbells. As described in greater detail below, the hardware scheduler of an APD is notified via a notification mechanism, such as a doorbell, when work (e.g., a command packet) has been placed into a software queue that has not been mapped to a hardware queue of the APD. Stated differently, the notification mechanism signals the hardware scheduler to detect unmapped software queues having work items and requests the hardware scheduler to map the software queues to hardware queues. In at least some implementations, the notification hardware “piggybacks” on the same doorbells that are part of submitting a command packet into a hardware queue of the command processor. However, before passing a doorbell to the command processor, the doorbell is checked by scheduling/queue-multiplexing mechanisms to determine if the queue targeted by the doorbell is currently mapped to a hardware queue of the APD. If so, the doorbell is forwarded to the command processor so the command processor is notified that a new command packet has arrived in one of the hardware queues. However, if the doorbell is associated with a software queue that is not mapped to a hardware queue of the APD, the hardware scheduler is notified through an interrupt (or another signaling mechanism) that an unmapped software queue currently has work. The hardware scheduler uses this knowledge of an unmapped software queue having work when determining which software queues to map to hardware queues of the APD or which software queues to disconnect from the hardware queues. Stated differently, instead of requiring the hardware scheduler to analyze each software queue to determine if a queue has work, the hardware scheduler is actively notified when an unmapped software queue has work, which increases the efficiency and performance of the hardware scheduler. Also, the applications submitting work items to the software queues do not need to be coded with complex mechanisms to notify the hardware scheduler when work is submitted to an unmapped software queue, which removes the software from the scheduling process and maintains the layer of abstraction provided by the ABI.

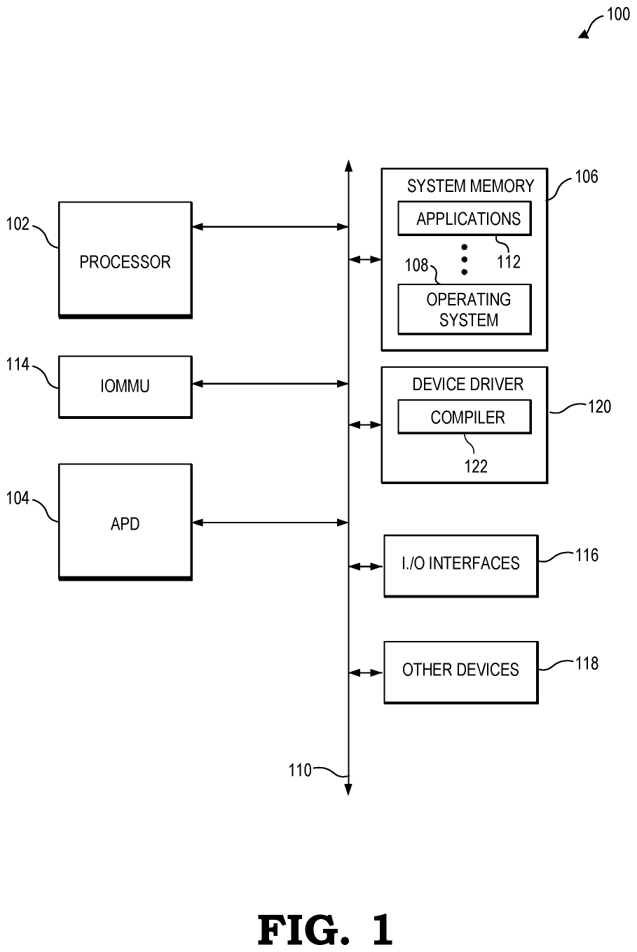

FIG. 1 illustrates an example processing system 100 (also referred to herein as “computing system 100”) in which one or more of the techniques described herein for performing hardware scheduling in an accelerated processor using unmapped-queue doorbells can be implemented. It is noted that the number of components of the processing system 100 varies from implementation to implementation. For example, in at least some implementations, there is more or fewer of each component/subcomponent than the number shown in FIG. 1. In at least some implementations, the processing system 100, includes other components not shown in FIG. 1 or is structured in other ways than shown in FIG. 1. Also, the components of the processing system 100 are implemented as hardware, circuitry, firmware, software, or any combination thereof.

In at least some implementations, the processing system 100 includes one or more processors 102, such as central processing units (CPU), and one or more accelerated processing devices (APDs) 104 (also referred to herein as “accelerated processor 104”, “processor 104”, or “accelerator unit 104”), such as a graphics processing unit (GPU). Other examples of an APD 104 include any of a variety of parallel processors, vector processors, coprocessors, general-purpose GPUs (GPGPUs), non-scalar processors, highly parallel processors, artificial intelligence (AI) processors, inference engines, machine learning processors, other multithreaded processing units, scalar processors, serial processors, or any combination thereof. The processor 102, in at least some implementations, includes one or more single-core or multi-core CPUs. In at least some implementations, the APD 104 includes any cooperating collection of hardware and or software that perform functions and computations associated with accelerating graphics processing tasks, data-parallel tasks, nested data-parallel tasks in an accelerated manner with respect to resources such as conventional CPUs, conventional graphics processing units (GPUs), and combinations thereof.

In the implementation of FIG. 1, the processor 102 and the APD 104 are formed and combined on a single silicon die or package to provide a unified programming and execution environment. This environment enables the APD 104 to be used as fluidly as the processor 102 for some programming tasks. In other implementations, the processor 102 and the APD 104 are formed separately and mounted on the same or different substrates. It should be appreciated that processing system 100, in at least some implementations, includes more or fewer components than illustrated in FIG. 1. For example, the processing system 100, in at least some implementations, additionally includes one or more input interfaces, non-volatile storage, one or more output interfaces, network interfaces, and one or more displays or display interfaces.

As illustrated in FIG. 1, the processing system 100 also includes a system memory 106, an operating system (OS) 108, a communications infrastructure 110, one or more software applications 112, an input-output memory management unit (IOMMU) 114, and input/output (I/O) interfaces 116, other devices 118. Access to system memory 106 is managed by a memory controller (not shown) coupled to system memory 106. For example, requests from the processor 102 or other devices for reading from or for writing to system memory 106 are managed by the memory controller. In some implementations, the one or more applications 112 include various programs or commands to perform computations that are also executed at the processor 102. The processor 102 sends selected commands for processing at the APD 104. The operating system 108 and the communications infrastructure 110 are discussed in greater detail below.

Within the processing system 100, the system memory 106 includes non-persistent memory, such as dynamic random-access memory (not shown). In at least some implementations, the system memory 106 stores processing logic instructions, constant values, variable values during execution of portions of applications or other processing logic, or other desired information. For example, in at least some implementations, parts of control logic to perform one or more operations on processor 102 reside within system memory 106 during execution of the respective portions of the operation by processor 102. During execution, respective applications, operating system functions, processing logic commands, and system software reside in system memory 106. Control logic commands that are fundamental to operating system 108 generally reside in system memory 106 during execution. In some implementations, other software commands (e.g., a set of instructions or commands used to implement a device driver 120) also reside in system memory 106 during execution of processing system 100.

The input-output memory management unit (IOMMU) 114 is a multi-context memory management unit. As used herein, context is considered the environment within which the kernels execute and the domain in which synchronization and memory management is defined. The context includes a set of devices, the memory accessible to those devices, the corresponding memory properties, and one or more command queues used to schedule execution of a kernel(s) or operations on memory objects. The IOMMU 114 includes logic to perform virtual to physical address translation for memory page access for devices, such as the APD 104. In some implementations, the IOMMU 114 also includes, or has access to, a translation lookaside buffer (TLB) (not shown). The TLB is implemented in a content addressable memory (CAM) to accelerate translation of logical (i.e., virtual) memory addresses to physical memory addresses for requests made by the APD 104 for data in system memory 106.

I/O interfaces 116 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices are coupled to I/O interfaces 106. Such peripheral devices include (but are not limited to) displays, keyboards, mice, printers, scanners, joysticks or other types of game controllers, media recording devices, external storage devices, network interface cards, and so forth. Other device(s) 118 are representative of any number and type of devices (e.g., multimedia device, video codec).

In at least some implementations, the communications infrastructure 110 interconnects the components of the processing system 100. Communications infrastructure 110 includes (not shown) one or more of a peripheral component interconnect (PCI) bus, extended PCI (PCI-E) bus, advanced microcontroller bus architecture (AMBA) bus, advanced graphics port (AGP), or other such communication infrastructure and interconnects. In some implementations, communications infrastructure 110 also includes an Ethernet network or any other suitable physical communications infrastructure that satisfies an application's data transfer rate requirements. Communications infrastructure 110 also includes the functionality to interconnect components, including components of the processing system 100.

A driver, such as device driver 120, communicates with a device (e.g., APD 104) through an interconnect or the communications infrastructure 110. When a calling program invokes a routine in the device driver 120, the device driver 120 issues commands to the device. Once the device sends data back to the device driver 120, the device driver 120 invokes routines in an original calling program. In general, device drivers are hardware-dependent and operating-system-specific to provide interrupt handling required for any necessary asynchronous time-dependent hardware interface. In some implementations, a compiler 122 is embedded within device driver 120. The compiler 122 compiles source code into program instructions as needed for execution by the processing system 100. During such compilation, the compiler 122 applies transforms to program instructions at various phases of compilation. In other implementations, the compiler 122 is a standalone application. In at least some implementations, the device driver 120 controls operation of the APD 104 by, for example, providing an application programming interface (API) to software (e.g., applications 112) executing at the processor 102 to access various functionality of the APD

The processor 102 includes (not shown) one or more of a control processor, field-programmable gate array (FPGA), application-specific integrated circuit (ASIC), or digital signal processor (DSP). The processor 102 executes at least a portion of the control logic that controls the operation of the processing system 100. For example, in at least some implementations, the processor 102 executes the operating system 108, and the one or more applications 112. In some implementations, the processor 102 initiates and controls the execution of the one or more applications 112 by distributing the processing associated with one or more applications 112 across the processor 102 and other processing resources, such as the APD 104.

The APD 104 executes commands and programs for selected functions, such as graphics operations and other operations that are particularly suited for parallel processing. In general, APD 104 is frequently used for executing graphics pipeline operations, such as pixel operations, geometric computations, and rendering an image to a display. In some implementations, APD 104 also executes compute processing operations (e.g., those operations unrelated to graphics such as video operations, physics simulations, computational fluid dynamics, etc.), based on commands or instructions received from the processor 102. For example, such commands include special instructions that are not typically defined in the instruction set architecture (ISA) of the APD 104. In some implementations, the APD 104 receives an image geometry representing a graphics image, along with one or more commands or instructions for rendering and displaying the image. In at least some implementations, the image geometry corresponds to a representation of a two-dimensional (2D) or three-dimensional (3D) computerized graphics image.

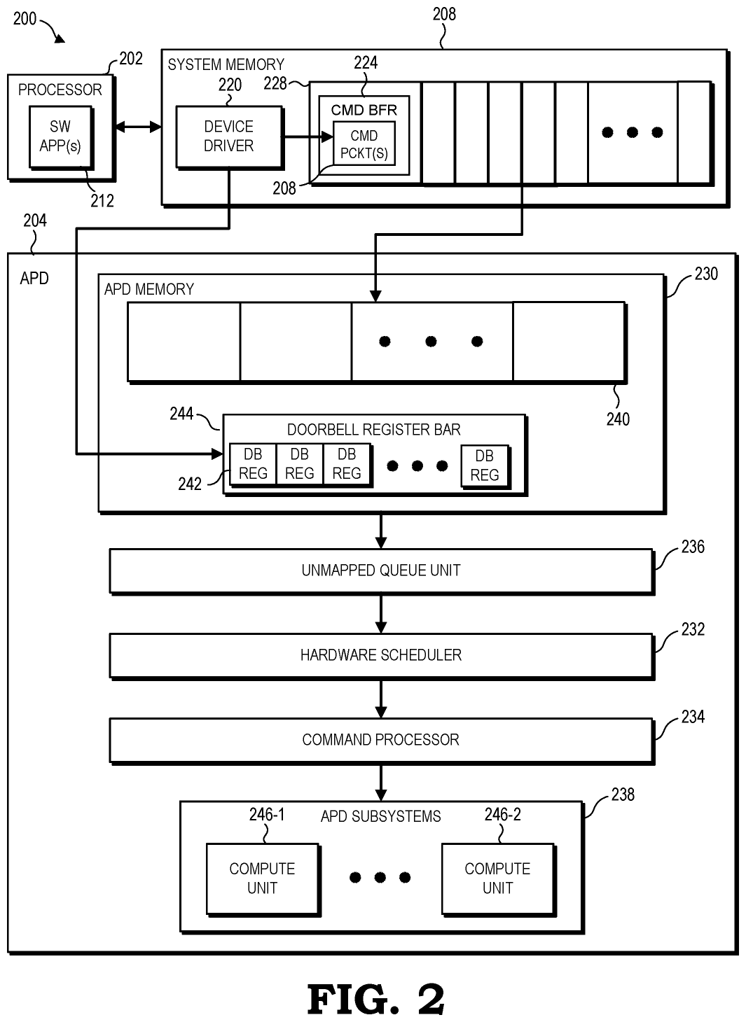

As described in greater detail below with respect to FIG. 2, the APD 104 includes one or more parallel processing units to perform computations in accordance with a single-instruction-multiple-data (SIMD) paradigm. In one or more implementations of the APD 104 is used to implement a GPU and, in these implementations, the parallel processing units are referred to as shader cores or streaming multi-processors (SMXs). Each parallel processing unit includes one or more processing elements such as scalar and/or vector floating-point units, arithmetic and logic units (ALUs), and the like. In at least some implementations, the parallel processing units also include special-purpose processing units (not shown), such as inverse-square root units and sine/cosine units.

FIG. 2 is a more detailed example of a processing system 200 (also referred to herein as “computing system 200”) in which one or more of the techniques described herein for performing hardware scheduling in an accelerated processor using unmapped-queue doorbells can be implemented. As shown, the processing system 200 includes at least a processor 202, an APD 204 (also referred to herein as “accelerated processor 204” or “processor 204”), and system memory 206. In at least some implementations, the processor 202, the APD 204, and the system memory 206 are implemented as previously described with respect to FIG. 1. It should be understood that the processing system 200 also includes other components which are not shown for brevity. For example, in at least some implementations, the processing system 200 includes additional components such as software, hardware, and firmware components in addition to, or different from, that shown in FIG. 2. In at least some implementations, the APD 204 includes other components, omits one or more of the illustrated components, has multiple instances of a component even if only one instance is shown in FIG. 2, is organized in other suitable manners, or a combination thereof.

In at least some implementations, the processing system 200 executes any of various types of software applications 212. In some implementations, as part of executing a software application 212, the processor 202 of the processing system 200 launches tasks to be executed at the APD 204. For example, when a software application 212 executing at the processor 202 requires graphics (or compute processing), the processor 202 provides graphics commands and graphics data (or compute commands and compute data) in a command buffer 224 in the system memory 206 (or APD memory 230) for subsequent retrieval and processing by the APD 204. In at least some implementations, one or more device drivers 220 translates the high-level commands from the software application 212 into low-level command packets 226 that can be understood by the APD 204. The device driver 220 writes the command packets 226 with commands corresponding to one or more tasks. The commands include, for example, draw commands, compute commands, global state updates, block state updates, a combination thereof, and the like. The device driver 220 organizes the command packet 226 in a specific command buffer 224, which, in at least some instances, comprises multiple command packets 226 for a specified task or set of tasks. In at least some implementations, the device driver 220 implements one or more software queues 228 for organizing and preparing the command buffers 224 for submission to a hardware queue 240 of the APD 204.

The device driver 220, in at least some implementations, includes software, firmware, hardware, or any combination thereof. In at least some implementations, the device driver 220 is implemented entirely in software. The device driver 220 provides an interface, an application programming interface (API), or a combination thereof, for communications access to the APD 204 and access to hardware resources of the APD 204. Examples of the device driver 220 include a kernel mode driver, a user mode driver, and the like.

As previously noted, the system memory 206 includes one or more memory buffers (including the command buffer 224) through which the processor 202 communicates (e.g., provided via the device driver 220) commands to the APD 204. In at least some implementations, such memory buffers are implemented as queues, ring buffers, or other data structures suitable for efficient queuing of work or command packets 226. In the instance of a queue, command packets are placed into and taken out of the queue. In at least some implementations, the system memory 206 includes indirect buffers that hold the actual commands (e.g., instructions, data, pointers non-pointers, and the like). For example, in some implementations, when the processor 202 communicates a command packet 226 to the APD 204, the command packet 226 is stored in the indirect buffer and a pointer to that indirect buffer is inserted in one or more entries (that store commands, data, or associated contexts) of the command buffer 224.

In at least some implementations, the APD 204 includes memory 230, one or more hardware schedulers (HWSs) 232, one or more processors, such as one or more command processors (CPs) 234, one or more unmapped queue units 236, one or more, and one or more APD subsystems 238 including, for example, computing resources and graphics/compute pipelines. It should be understood that although the hardware scheduler 232, the command processor 234, and the unmapped queue unit 236 are shown as separate components in FIG. 2, in other implementations, two or more of these components are part of the same component. For example, in at least some implementations, the hardware scheduler 232 is part of the command processor 234, the unmapped queue unit 236 is part of the hardware scheduler 232, the unmapped queue unit 236 is part of the command processor 234, or the like.

The APD memory 230, in at least some implementations, is on-chip memory that is accessible to both the APD 204 and the processor 202. The APD memory 230 includes, for example, hardware queues 240 and doorbell registers 242. In at least some implementations, the hardware queues 240 is a data structure or buffer implemented in the APD memory 230 that is accessible to the CPU 202 and the APD 204. A hardware queue 240 receives command buffers 224 from the device driver 220 and holds the buffers 224 until the command processor 234 selects them for execution. In at least some implementations, there are multiple hardware queues dedicated to different workloads, such as graphics, compute, or copy operations. The hardware queues 240, in at least some implementations, are HSA queues.

The doorbell registers 242 are registers implemented in the APD memory 230 that facilitate communication between the device driver 220 running on the processor 202 and the hardware scheduler 232 of the APD 204. The doorbell registers 242 act as signaling mechanisms to inform the APD 204 when a new command buffer 224 has been submitted to a hardware queue 240 and is ready for execution. In at least some implementations, when the device driver 220 submits a command buffer 224 (work) to a hardware queue 240, the device driver 220 writes a specific value to the corresponding doorbell register 242. As described in greater detail below, in at least some implementations, the device driver 220 is configured to write to a doorbell register 242 mapped to a software queue 228. In these implementations, when the device driver 220 prepares a command buffer 224 in a software queue 228, the device driver 220 writes to a doorbell register 242 mapped to that software queue 228. In at least some implementations, the doorbell registers 242 are implemented using memory-mapped input/output (MMIO) such that the doorbell registers 242 are mapped into the address space of the processor 202. This allows the device driver 220 running on the processor 202 to access and manipulate the doorbell registers 242 using regular memory read and write operations. The doorbell registers 242, in at least some implementations, are maintained in a doorbell bar 244, which is a region of APD memory 230 designated for the doorbell registers 242. As described in greater detail below, in some implementations, each software queue 228 created by the device driver 220 is associated with a separate doorbell register 242. However, in other implementations, two or more software queues 228 are associated with the same doorbell register 242.

The hardware scheduler 232, in at least some implementations, maps the software queues 228 in the system memory 206 to the hardware queues 240 in the APD memory 230. In at least some implementations, the hardware scheduler 232 also keeps track of the command buffers 224 submitted to the hardware queues 240 by the device driver 220 or the command buffers 224 written by the device driver 220 to a software queue 228 that is mapped to a hardware queue 240 (also referred to as a “mapped software queue 228”). The hardware scheduler 232 also determines the priority of the command buffers 224 in the hardware queues 240 based on factors such as the type of task, resource availability, and scheduling policies. In at least some implementations, the hardware scheduler 232 is implemented as hardware, circuitry, firmware, a firmware-controlled microcontroller, software, or any combination thereof.

The command processor 234, in at least some implementations, detects when a command buffer 224 is submitted to a hardware queue 240. For example, the command processor 234 detects a doorbell associated with the hardware queue 240. Stated differently, the command processor 234 detects when the device driver 220 writes to a doorbell register 242 associated with hardware queue 240 and changes the value of the doorbell register 242. The command processor 234 reads the command packets 226 within the command buffer 224 and decodes the packets 226 to understand what actions need to be performed, and dispatches the appropriate commands to the corresponding execution units within the APD 204, such as shader cores, fixed-function units, or memory controllers. In at least some implementations, the command processor 234 is implemented as hardware, circuitry, firmware, a firmware-controlled microcontroller, software, or any combination thereof.

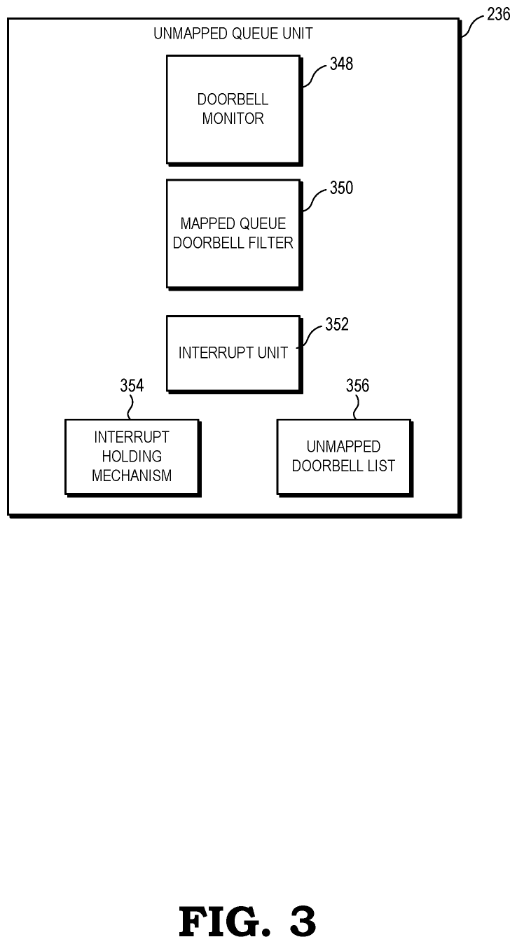

The unmapped queue unit 236 includes one or more components for facilitating hardware scheduling in the APD 204 using unmapped-queue doorbells. For example, as shown in FIG. 3, the unmapped queue unit 236, in at least some implementations, includes a doorbell monitor 348, a mapped queue doorbell filter 350, an interrupt unit 352, an interrupt holding mechanism 354, and an unmapped doorbell list 356. Each of these components is described in greater detail below. The unmapped queue unit 236, in at least some implementations, monitors for doorbells (e.g., writes to doorbell registers 242) associated with a software queue 228 that is not mapped to a hardware queue 240 of the APD 204. Such a software queue 228 is referred to herein as an “unmapped software queue 228”. When the unmapped queue unit 236 detects a doorbell associated with an unmapped software queue 228, the unmapped queue unit 236 notifies the hardware scheduler 232 that an unmapped software queue 228 has a command buffer 224 ready for processing. The hardware scheduler 232 then uses this knowledge to determine how and when to map the unmapped software queue 228 to a hardware queue 240 so that the command processor 234 is able to process the command buffer 224. If the doorbell is associated with a mapped software queue 228, the unmapped queue unit 236 passes the doorbell to command processor 234 or the command processor 234 detects the doorbell. For example, the unmapped queue unit 236 sends a doorbell signal to the command processor 234 to notify the command processor 234 that the hardware queue 240 has work (e.g., a command buffer 224). In at least some implementations, the unmapped queue unit 236 is implemented as hardware, circuitry, firmware, a firmware-controlled microcontroller, software, or any combination thereof.

Referring again to FIG. 2, the APD subsystems 238, in at least some implementations, includes various processing blocks, APD compute resources, and the like. As used herein, the term “block” refers to a module (e.g., circuitry) included in an ASIC, an execution pipeline of a CPU, a graphics pipeline of a GPU, a combination thereof, or the like. Such a module includes, but is not limited to, a cache memory, an arithmetic logic unit, a multiply/divide unit, a floating point unit, a geometry shader, a vertex shader, a pixel shader, various other shaders, a clipping unit, a z-buffer (e.g., depth buffer), a color buffer, or some other processing module. The APD subsystems 238 include any cooperating collection of hardware and or software that perform functions and computations associated with accelerating graphics processing tasks, data-parallel tasks, nested data-parallel tasks in an accelerated manner with respect to resources such as conventional CPUs, conventional graphics processing units (GPUs), and combinations thereof.

In various implementations, the APD subsystems 238 include one or more compute units (CUs) 246 (illustrated as CU 246-1 and CU 246-2), such as one or more processing cores that include one or more single-instruction multiple-data (SIMD) units (illustrated that are each configured to execute a thread concurrently with execution of other threads in a wavefront by other SIMD units, e.g., according to a SIMD execution model. The SIMD execution model is one in which multiple processing elements share a single program control flow unit and program counter and thus execute the same program but are able to execute that program with different data. The processing cores are also referred to as shader cores or SMXs. The number of compute units 246 implemented in the APD 204 is configurable. Each compute unit 246 includes one or more processing elements such as scalar and or vector floating-point units, ALUs, and the like. In various implementations, the compute units 246 also include special-purpose processing units, such as inverse-square root units and sine/cosine units.

Each of the one or more compute units 246 executes a respective instantiation of a particular work item to process incoming data, where the basic unit of execution in the one or more compute units 246 is a work item (e.g., a thread). Each work item represents a single instantiation of, for example, a collection of parallel executions of a kernel invoked on a device by a command that is to be executed in parallel. A work item executes at one or more processing elements as part of a workgroup executing at a compute unit 246.

The APD 204 issues and executes work-items, such as groups of threads executed simultaneously as a “wavefront”, on a single SIMD unit. Wavefronts, in at least some implementations, are interchangeably referred to as warps, vectors, or threads. In some implementations, wavefronts include instances of parallel execution of a shader program, where each wavefront includes multiple work items that execute simultaneously on a single SIMD unit in line with the SIMD paradigm (e.g., one instruction control unit executing the same stream of instructions with multiple data).

The parallelism afforded by the one or more compute units 246 is suitable for graphics-related operations such as pixel value calculations, vertex transformations, tessellation, geometry shading operations, and other graphics operations. A graphics processing pipeline accepts graphics processing commands from the CPU 202 and thus provides computation tasks to the compute units 246 for execution in parallel. Some graphics pipeline operations, such as pixel processing and other parallel computation operations, require that the same command stream or compute kernel be performed on streams or collections of input data elements. Respective instantiations of the same compute kernel are executed concurrently on multiple SIMD units in the one or more compute units 246 to process such data elements in parallel. As referred to herein, for example, a compute kernel is a function containing instructions declared in a program and executed on an accelerated processing device (APD) compute units 246. This function is also referred to as a kernel, a shader, a shader program, or a program.

As described above, the processing system 200 implements multiple software queues 228 for managing command buffers 224 created by the device driver 220. Implementing multiple software queues 228 allows more work to be sent to the APD 204 in parallel. For example, multiple users (such as a web browser and a game) of the APD 204 are able to simultaneously send work to the APD 204 by having their command packets placed into different software queues 228. The hardware scheduler 232 maps the software queues 228 to the hardware queues 240 of the APD 204 and the command processor monitors the doorbell registers 242 mapped to the hardware queues 240 to determine when a command buffer 224 has been submitted to a hardware queue 240 by the device driver 220.

In at least some implementations, the hardware of the APD 204 has a limited number of pipes, each of which has a fixed number of hardware queues 240. Therefore, the command processor 234 is able to only look at a finite number of hardware queues 240 simultaneously. For example, in one configuration, the APD 204 implements 32 (or some other number) hardware queues 240. In this configuration, if 1000 software queues 228 have been created, the hardware scheduler 232 only maps 32 of these 1000 software queues 228 to the hardware queues 240 at a time. Therefore, in conventional configurations, the hardware scheduler 232 or command processor 234 is only notified when command buffers 224 are placed in one of the 32 mapped software queues 228 and, thus, the command processor 234 only processes command buffers 224 in the 32 hardware queues 240 regardless of whether a command buffer 224 has been placed in any of the remaining unmapped software queues 228. In at least some implementations, the hardware scheduler 232 implements one or more time multiplexing techniques when determining which subset of software queues 228 to map to the hardware queues 240. However, in conventional configurations, the hardware scheduler 232 performs the time multiplexing without knowledge of which software queues 228 have a command buffer 224 (e.g., work). Therefore, in a conventional configuration, the hardware scheduler 232 selects software queues 228 without a command buffer 224 to map to a hardware queue 240 while other software queues 228 with a command buffer 224 are waiting to be mapped.

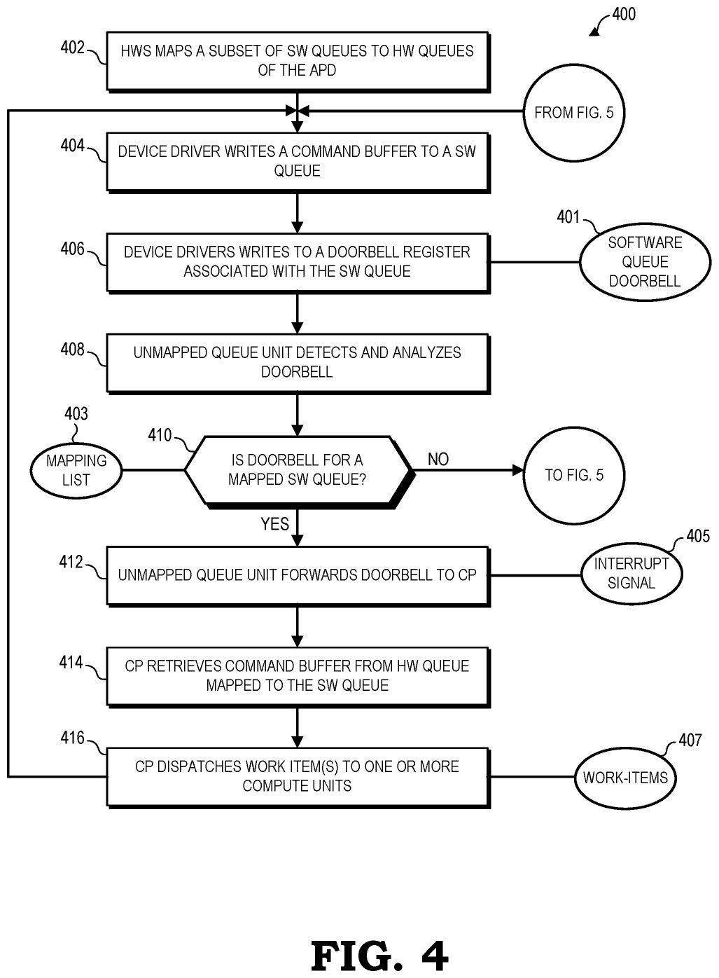

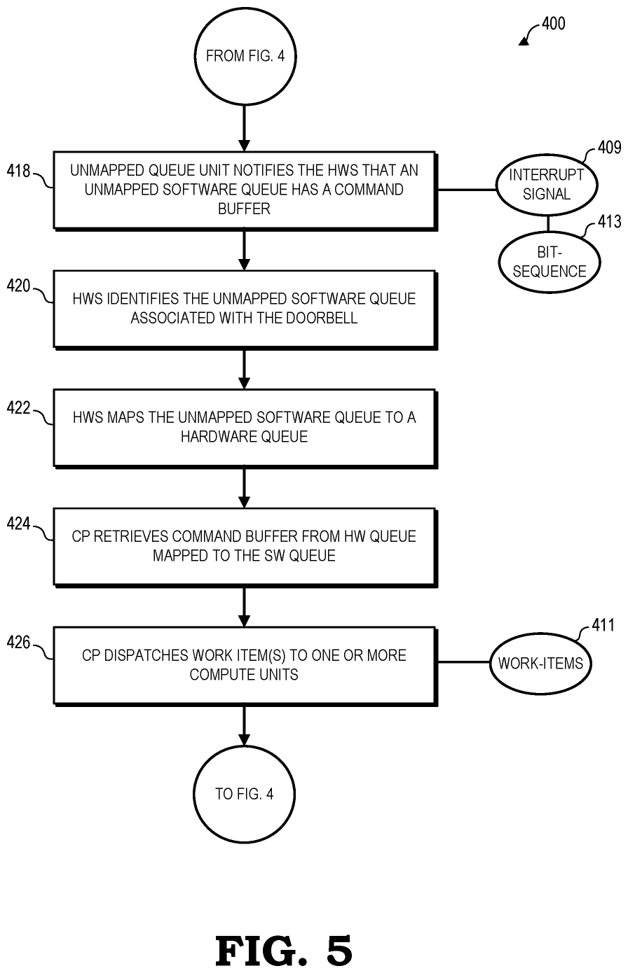

As such, in at least some implementations, the APD 204 is configured to detect when the device driver 220 writes a command buffer 224, that is, submits work, to an unmapped software queue 228 so that the hardware scheduler 232 prioritizes the unmapped software queue 228 over other software queues 228 without work when determining which software queues 228 to map the hardware queues 240 of the APD 204. One example of this process is illustrated in FIG. 4 and FIG. 5. For example, FIG. 4 and FIG. 5 together illustrate an example method 400 performed by the APD 204 for detecting work in unmapped software queues 228 and performing hardware scheduling using unmapped software queue doorbells. For purposes of description, the method 400 is described with respect to an example implementation at the processing system 200 of FIG. 2, but it will be appreciated that, in other implementations, the method 400 is implemented at processing devices having different configurations. Also, the method 400 is not limited to the sequence of operations shown in FIG. 4 and FIG. 5, as at least some of the operations can be performed in parallel or in a different sequence. Moreover, in at least some implementations, the method 400 can include one or more different operations than those shown in FIG. 4 and FIG. 5.

At block 402, the hardware scheduler 232 maps a subset of software queues 228 generated by the device driver 220 to hardware queues 240 of the APD 204. In at least some implementations, the hardware scheduler 232 maps a software queue 228 to a hardware queue 240 using an identifier, index value, or other identifying information that uniquely identifies the software queue 228. It should be understood that the hardware scheduler 232 is able to map and disconnect software queues 228 to/from hardware queues 240 at different points in time throughout the method 400. At block 404, the device driver 220 places work into a software queue 228. For example, the device driver 220 writes one or more command packets 226 to a command buffer 224 maintained by the software queue 228. At block 406, the device driver 220 “rings” a software queue doorbell 401 associated with the software queue 228 into which the device driver 220 placed the work. For example, the device driver 220 “rings” the doorbell 401 (also referred to herein as generating a “doorbell notification 401”) by writing to a doorbell register 242 associated with the software queue 228. In at least some implementations, the device driver 220 writes a specific value, such as an identifier or a value representing the location of the associated command buffer 224, to the doorbell register 242.

At block 408, the unmapped queue unit 236 detects that a doorbell 401 has been generated for the software queue 228. For example, the doorbell monitor 348 of the unmapped queue unit 236 monitors the doorbell bar 244 for changes to any of the doorbell registers 242. In this example, the doorbell monitor 348 detects when the device driver 220 writes a value to a doorbell register. At block 410, the unmapped queue unit 236 determines if the doorbell 401 is associated with a mapped software queue 228 or an unmapped software queue 228. For example, the mapped queue doorbell filter 350 of the unmapped queue unit 236 determines the identifier of the software queue 228 associated with the doorbell register 242 that generated the doorbell 401. The mapped doorbell queue filter 350 compares the software queue identifier to software queue identifiers in a hardware queue mapping list 403. The mapping list 403, in at least some implementations, identifies the hardware queues 240 and the software queues 228 currently mapped to each of the hardware queues 240.

If the identifier of the software queue 228 associated with the doorbell 401 matches a software queue identifier in the mapping list 403, the unmapped queue unit 236 determines that the software queue 228 is currently mapped to a hardware queue 240 and that the doorbell 401 is a mapped queue doorbell. At block 412, the unmapped queue unit 236 forwards the doorbell 401 to the command processor 234. For example, the interrupt unit 352 of the unmapped queue unit 236 generates and sends an interrupt 405, or another type of signal, to the command processor 234. The interrupt 405, in at least some implementations, includes information, such as an identifier or memory address, identifying the doorbell register 242 that generated the doorbell 401. In other implementations, the interrupt 405 does not include this information and acts as a trigger for the command processor 234 to go and check each of the hardware queues 240 for new work (e.g., a command buffer 224). In some implementations, the command processor 234 monitors the hardware queues 240 for new work. In at least some of these implementations, if the unmapped queue unit 236 determines that a software queue 228 associated with a doorbell 401 is currently mapped to a hardware queue 240, the unmapped queue unit 236 does not send the interrupt 405 to the command processor 234 because the command processor 234 will automatically detect new work in a hardware queue 240.

At block 414, the command processor 234 retrieves the work (e.g., command buffer 224) from the hardware queue 240 mapped to the software queue 228. In at least some implementations, if the software queue 228 is mapped to a hardware queue 240, the device driver 220 moves or copies the work (e.g., command buffer 224) from the software queue 228 to the hardware queue 240). At block 416, the command buffer 224 dispatches one or more work-items 407 for the work retrieved from the hardware queue 240 to one or more compute units 246 of the APD 204. The method 400 then returns to block 404.

Referring again to block 410, if the identifier of the software queue 228 associated with the doorbell 401 does not match a software queue identifier in the mapping list 403, the unmapped queue unit 236 determines the doorbell 401 is an unmapped queue doorbell and the associated software queue 228 is not currently mapped to a hardware queue 240. Stated differently, the unmapped queue unit 236 determines that the detected software doorbell queue 401 is an unmapped queue doorbell. The method 400 then flows to block 418 of FIG. 4. At block 418, the unmapped queue unit 236 notifies the hardware scheduler 232 that an unmapped software queue 228 has work (e.g., a command buffer 224) for processing. For example, the interrupt unit 352 of the unmapped queue unit 236 generates and sends an interrupt 409, or another type of signal or message, to the hardware scheduler 232.

At block 420, responsive to receiving the interrupt 409, the hardware scheduler 232 identifies the unmapped software queue 228 associated with the doorbell 401. For example, in at least some implementations, the interrupt 409 signals or triggers the hardware scheduler 232 to search through each of the unmapped software queues 228 either directly, or indirectly by searching through each of the doorbell registers 242, to identify the unmapped software queue(s) 228 that has work. In other implementations, as described in greater detail below, the interrupt 409 signals the hardware scheduler 232 to process the unmapped doorbell list 356 maintained by the unmapped queue unit 236 to identify the unmapped software queue(s) 228 that has work.

At block 422, after identifying the unmapped software queue(s) 228 that has work, the hardware scheduler 232 prioritizes the identified unmapped software queue(s) 228 over unmapped software queues 228 without work, and maps the identified unmapped software queue(s) 228 to a hardware queue 240 of the APD 204. At block 424, the command processor 234 retrieves the work (e.g., command buffer 224) from the hardware queue 240 mapped to the software queue 228. At block 426, the command buffer 224 dispatches one or more work-items 411 for the work retrieved from the hardware queue 240 to one or more compute units 246 of the APD 204. The method 400 then returns to block 404.

In some instances, after the unmapped queue unit 236 sends an initial interrupt 409 associated with an unmapped software queue 228 to the hardware scheduler 232 at block 418 of FIG. 5, additional work may be placed in the same unmapped software queue 228. If multiple instances of work are placed into an unmapped software queue 228 after the hardware scheduler 232 receives the initial interrupt 409 associated with the unmapped software queue 228, the hardware scheduler 232 will detect each instance of work when the hardware scheduler 232 processes the initial interrupt 409 for mapping the software queue 228. Therefore, the unmapped queue unit 236 only needs to send one interrupt 409 to notify the hardware scheduler 232 that an unmapped software queue 228 has work until the hardware scheduler 232 indicates to the unmapped queue unit 236 that the one interrupt 409 has been processed. Stated differently, even though the unmapped queue unit 236 may detect multiple doorbells 401 for the same unmapped software queue 228 after an initial interrupt 409 was sent to the hardware scheduler 232, the unmapped queue unit 236, in at least some implementations, does not send another interrupt 409 for the same queue 228 until the hardware scheduler 232 indicates to the unmapped queue unit 236 that the initial (pending) interrupt 409 has been processed.

As such, in at least some implementations, the unmapped queue unit 236 implements an interrupt holding mechanism 354 to pause the sending of interrupts 409 (or other signals or messages) to the hardware scheduler 232 after an initial interrupt 409 is sent for unmapped software queue 228. Stated differently, the interrupt holding mechanism 354 pauses or prevents additional signals from being transmitted to the hardware scheduler 232 when additional unmapped queue doorbells for the software queue 228 are detected until the hardware scheduler processes the pending interrupt 409. The interrupt holding mechanism 354, in at least some implementations, is implemented as a flag, although other implementations are also applicable. In at least some implementations, a flag is implemented for each unmapped software queue 228 detected by the unmapped queue unit 236. When the unmapped queue unit 236 sends an initial interrupt 409 to the hardware scheduler 232 at block 418 of FIG. 5, the unmapped queue unit 236 sets the flag (e.g., changes a bit value from a zero value to a non-zero value) to indicate that an interrupt 409 has been sent to, and has not been processed by, the hardware scheduler 232. When the unmapped queue unit 236 detects another doorbell associated with the same unmapped software queue 228 at block 410 of FIG. 4, the unmapped queue unit 236 checks the flag for the queue 228 to determine if there is a pending interrupt 409 for the unmapped software queue 228 waiting to be processed by the hardware scheduler 232. If the flag does not indicate (e.g., the flag has a bit value of 0) that there is a pending interrupt 409, the unmapped queue unit 236 sends another interrupt 409 to the hardware scheduler 232 for the unmapped software queue 228. If the flag indicates (e.g., the flag has a bit value of 1) that there is a pending interrupt 409, the unmapped queue unit 236 does not send another interrupt 409 to the hardware scheduler 232 for the unmapped software queue 228. However, in at least some implementations, the unmapped queue unit 236 continues to update the unmapped doorbell list 356 (e.g., changes bit values), as described below, to indicate that additional work has been placed in the unmapped software queue 228. The unmapped queue unit 236 then continues to monitor for additional doorbells (e.g., block 408 of FIG. 4).

In at least some implementations, when the hardware scheduler 232 processes the pending interrupt 409 at any one of block 418 to block 422 of FIG. 5 or maps the unmapped queue 228, the hardware scheduler 232 notifies the unmapped queue unit 236 that the pending interrupt 409 has been processed. When the unmapped queue unit 236 receives or detects this notification from the hardware scheduler 232, the unmapped queue unit 236 clears the flag (e.g., changes the bit value from a non-zero value to a zero value using, for example, a bitmask) for the associated software queue 228. The notification from the hardware scheduler 232 can be implemented in various ways. For example, in at least some implementations, the hardware scheduler 232 sends an interrupt, signal, or message indicating to the unmapped queue unit 236 that hardware scheduler 232 has processed the pending interrupt 409. In other implementations, the hardware scheduler 232 sets a specific bit in the unmapped doorbell list 356 or clears the bit(s) in the unmapped doorbell list 356 indicating that the software queue 228 has work. For example, the hardware scheduler 232 uses a bitmask to clear one or more bits in the unmapped doorbell list 356. The unmapped queue unit 236 detects the changes in the unmapped doorbell list 356 and clears the flag for the associated software queue 228 using, for example, a bitmask.

In at least some implementations, the APD 204 is configured to implement various mechanisms that allow the hardware scheduler 232 to identify an unmapped software queue 228 associated with a doorbell 401 at block 420 of FIG. 5. As described below, these mechanisms configure the APD 204 to perform interrupt-based polling of software queues 228 compared to, for example, time-based polling. The interrupt-based polling described herein is provides the benefit of the hardware scheduler 232 not needing to search the read-and-write pointers of all software queues 228 continuously. This allows the hardware scheduler 232 to avoid checking for work in unmapped software queues when 228 that are empty resulting in lower power utilization. Another benefit is that the unmapped doorbell list 356 becomes more accurate and the hardware scheduler 232 needs to search fewer unmapped software queues 228 when an unmapped queue doorbell 401 is detecting, which results in faster scheduling of software queues 228 when new work is put into them.

For example, in at least some implementations, each software queue 228 is mapped to an individual bit(s) in the unmapped doorbell list 356. Stated differently, if there are N software queues 228, each of the N software queues 228 is mapped to a different bit of N bits. The unmapped doorbell list 356, in at least some implementations, is a mapping data structure, such as a bitmap, bit array, first in first out buffer, or the like. In at least some implementations, the unmapped doorbell list 356 is stored in the APD memory 230. The software queues 228, in at least some implementations, are directly mapped to individual bits in the unmapped doorbell list 356. In other implementations, the software queues 228 are mapped to individual bits in the unmapped doorbell list 356 through the doorbell register 242. For example, each software queue 228 is mapped to a separate doorbell register 242 and each doorbell register 242 is mapped to an individual bit(s) in the unmapped doorbell list 356. Each bit in the unmapped doorbell list 356, in at least some implementations, is associated with (or represents) an identifier or an index corresponding to a specified software queue 228 or doorbell register 242 mapped to the software queue 228. When the unmapped queue unit 236 determines that a detected doorbell 401 is associated with an unmapped software queue 228 at block 410 of FIG. 4, the unmapped queue unit 236 sets the bit (e.g., changes a zero value to a non-zero value) in the unmapped doorbell list 356 for the software queue 228 (or doorbell register 242) associated with the doorbell 401. When the hardware scheduler 232 receives the interrupt 409 generated at block 418 of FIG. 5, the hardware scheduler 232 reads the unmapped doorbell list 356 to identify the bit(s) having a non-zero value, which indicates to the hardware scheduler 232 that the software queue 228 mapped to the bit (either directly or through a doorbell register 242) has work.

In at least some implementations, the interrupt 409 includes a bit sequence 413 directly representing all of the software queues 228. Alternatively, the bit sequence 413 indirectly represents the software queues 228 through the doorbell registers 242. For example, each bit of the bit sequence 413 represents a doorbell register 242 that is mapped to a software queue 228. At block 410 of FIG. 4, when the unmapped queue unit 236 determines that the doorbell 401 is associated with an unmapped software queue 228, the unmapped queue unit 236 sets the bit (e.g., changes a zero value to a non-zero value) in the bit sequence 413 for the software queue 228 (or doorbell register 242) associated with the doorbell 401. At block 420 of FIG. 5, when the hardware scheduler 232 receives the interrupt 409 generated at block 418 of FIG. 5, the hardware scheduler 232 identifies any bits in the bit sequence 413 having a non-zero value and their positions in the bit sequence 413. The hardware scheduler 232 compares this information against the information in the unmapped doorbell list 356 to determine the software queue 228 (or the doorbell register 242) associated with the identified non-zero value in the bit sequence 413. If the bit sequence 413 is mapped to doorbell registers 242, the hardware scheduler 232 identifies the software queue 228 associated with the doorbell 501 based on based on information such as a software queue identifier, index value, write pointer, or the like, within the doorbell register 242 identified from the unmapped doorbell list 356 based on the bit sequence 413.

In other implementations, multiple software queues 228 are aliased onto the same bit in the unmapped doorbell list 356 either directly or indirectly through the doorbell register 242. Stated differently, subsets of the software queues 228 or doorbell registers 242 are mapped to the same bit in the unmapped doorbell list 356. For example, if the unmapped doorbell list 356 has 2 bits and there are 1000 software queues 228 (or doorbell registers 242), a first bit of the unmapped doorbell list 356 is mapped to software queues (or doorbell registers) 0 to 499 and a second bit of the unmapped doorbell list 356 is mapped to software queues (or doorbell registers) 500 to 999. At block 410 of FIG. 4, when the unmapped queue unit 236 determines that a detected doorbell 401 is associated with an unmapped software queue 228, the unmapped queue unit 236 sets the bit (e.g., changes a zero value to a non-zero value) in the unmapped doorbell list 356 for the software queue 228 (or doorbell register 242) associated with the doorbell 401. When the hardware scheduler 232 receives the interrupt 409 generated at block 418 of FIG. 5, the hardware scheduler 232 reads the unmapped doorbell list 356 to identify the bit(s) having a non-zero value. The bit(s) having a non-zero value indicates to the hardware scheduler 232 which subset of the software queues 228 includes the software queue 228 associated with the doorbell 401, or indicates which subset of the doorbell registers 242 includes the doorbell register 242 that generated the doorbell 401. At block 420 of FIG. 5, the hardware scheduler 232 searches through the subset of software queues 228 determined from the unmapped doorbell list 356 to identify the unmapped software queue 228 that has work (e.g., a command buffer 224). In implementations where the doorbell registers 242 are mapped in the unmapped doorbell list 356, the hardware scheduler 232 searches through the subset of doorbell registers 242 determined from the unmapped doorbell list 356 to identify the doorbell register 242 that generated the doorbell 401. The hardware scheduler 232 then identifies the unmapped software queue 228 associated with the doorbell register 242 as described above.

In other implementations, instead of the interrupt 409 only acting as a signal to trigger the hardware scheduler 232 to look at the unmapped doorbell list 356, the interrupt 409 includes a bit sequence 413 performing the aliasing described above. In these implementations, when the hardware scheduler 232 receives the interrupt 409 generated at block 418 of FIG. 5, the hardware scheduler 232 compares or indexes the bit(s) having a non-zero value in the bit sequence 413 to the unmapped doorbell list 356 for identifying the subset of software queues 228 (or doorbell registers 242) mapped to the bit(s).

In at least some implementations, the unmapped doorbell list 356 comprises a plurality of register arrays for recording doorbells 401 associated with unmapped software queue 228. In these implementations, when the unmapped queue unit 236 detects a doorbell 401 associated with an unmapped software queue 228 at block 410 of FIG. 4, the unmapped software queue 228 records the doorbell 401 in one of the register arrays by, for example, changing a zero value to a non-zero value (e.g., 1). The interrupt 409 sent by the unmapped queue unit 236 at block 418 of FIG. 5, notifies the hardware scheduler 232 to look at the plurality of register arrays to identify at least the register array having a doorbell register 242 with a non-zero value. The hardware scheduler 232 determines the unmapped software queue 228 associated with the doorbell register 242 having the non-zero value in the register array and prioritizes this unmapped software queue 228 over other unmapped software queues 228 having no work for mapping to a hardware queue 240. If multiple software queues 228 are associated with the doorbell register 242 having the non-zero value in the register array, the hardware scheduler 232 searches through all of these unmapped software queues 228 to determine which unmapped software queue(s) 228 has work. In at least some implementations, the interrupt 409 sent by the unmapped queue unit 236 at block 418 of FIG. 5, notifies the hardware scheduler 232 of the specific register array to look that has a doorbell register 242 with a non-zero value.

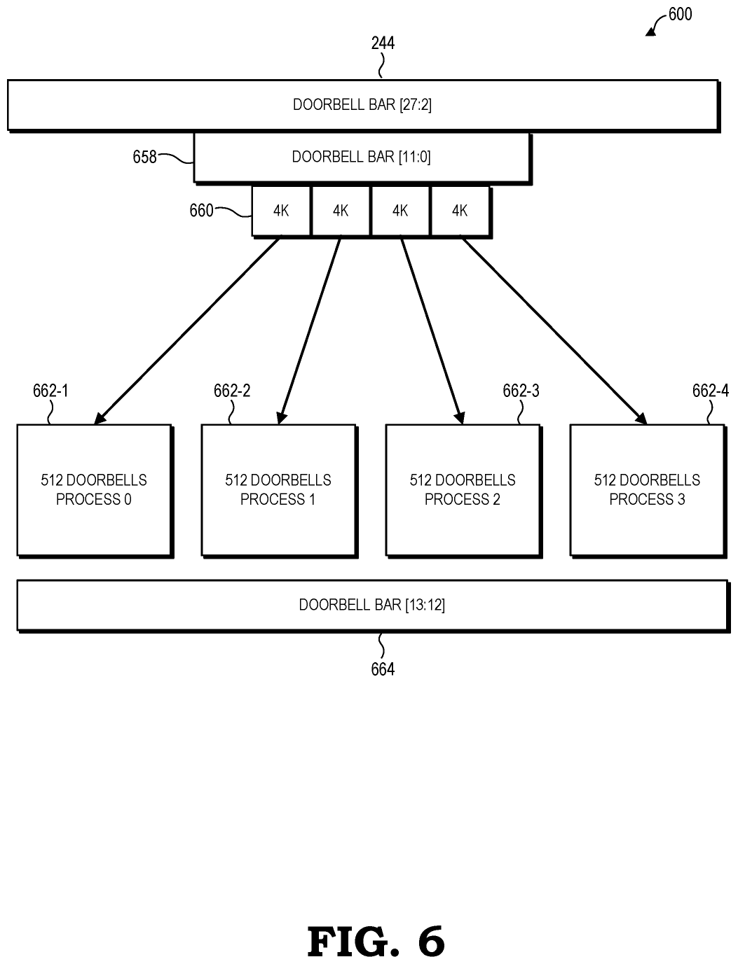

FIG. 6 illustrates one example configuration 600 of the plurality of register arrays for recording or mapping doorbells 401 associated with unmapped software queues 228. However, it should be understood that other configures of the register arrays are also applicable. In this example, the doorbell bar 244 has a memory address range of [27:2], although other memory address ranges are also applicable. The memory address range [11:0] 658 divides the doorbell bar 244 into 4K memory pages 660. The doorbell bar 244 is split into four 512-bit register arrays 662 (illustrated as doorbell array 662-1 to doorbell array 662-4). Each of the 512 bits in a doorbell array 662 represents one or more doorbells. Therefore, in this example, every process writing work to the APD 204 is allocated 512 doorbells. In at least some implementations, each of the doorbell arrays 662 is indexed by doorbell address bits [13:3]. The two higher-order bits 664 (e.g., [13:12]) are used to index into one of the doorbell arrays 662, and the remaining address bits (e.g., [11:3]) are used to index into the 512 doorbells of the doorbell array 662. In at least some implementations, each of the doorbell arrays 662 supports a set mask and a clear mask for simultaneously updating each doorbell array 662, with the set taking priority over the clear.

In one example, when the unmapped queue unit 236 detects a doorbell 401 associated with an unmapped software queue 228 at block 410 of FIG. 4, the unmapped queue unit 236 uses address bits [13:3] to decode the doorbell 401 and to record the doorbell in one of the doorbell arrays 658. In at least some implementations, the unmapped queue unit 236 uses address bits [13:12] of the doorbell 401 to identify the doorbell array 658 mapped to that doorbell 401. The unmapped queue unit 236 then uses address bits [11:3] of the doorbell 401 to index into the identified doorbell array 658 to identify one (or more) of the 512 bits to set for the doorbell 401. For example, the unmapped queue unit 236 records the doorbell 401 for the unmapped software queue 228 by changing a zero value of the identified bit(s) to a non-zero value to indicate that the software queue 228 associated with the doorbell 401 has work (e.g., a command buffer 224). At block 418 of FIG. 5, the unmapped queue unit 236 then sends an interrupt 409 to notify the hardware scheduler 232 that an unmapped software queue 228 has work. At block 420 of FIG. 5, the hardware scheduler 232 scans the plurality of doorbell arrays 658 to determine which unmapped software queue(s) 228 has work by identifying the doorbell array 658 that includes a non-zero value for one (or more) of the 512 bits representing a doorbell 401 generated for the unmapped software queue(s) 228.

In at least some implementations, the APD 204 implements a register that consolidates the doorbell bits in the doorbell arrays 662 to allow the hardware scheduler 232 to quickly identify the doorbell array(s) 662 and segment(s) inside the array(s) 662 having a non-zero value. In the example provided above with respect to FIG. 6, a 32-bit register is implemented that consolidates the 2048 bits between the four doorbell arrays 662, where each bit of the register corresponds to 64-bits of the total array in increasing fashion. In at least some implementations, the interrupt 409 generated by the unmapped queue unit 236 at block 418 of FIG. 5 triggers the processor to read the consolidation register to identify the doorbell array 662 and segment inside the array 662 having a non-zero value (e.g., an unmapped queue doorbell). Also, in at least some implementations, the APD 204 implements an index register that is provided to the hardware scheduler 232 for private read and writes. In the example provided above with respect to FIG. 6, the hardware scheduler 232 is able to select one of 32 64-bit values of the 2048 bits provided across the plurality of doorbell arrays 662. The hardware scheduler 232, in at least some implementations, clears any of the bits in the plurality of doorbell arrays 662 using, for example, a data mask (e.g., a 64-bit data mask) and an appropriate index.

It should be understood that the separation of doorbells 401 for unmapped software queues 228 into the four sets of 512 doorbells, and the setting of a bit for any ring to an unmapped doorbell, can be implemented in other ways. For example, in at least some implementations, the doorbells 401 that arrive for unmapped software queues 228 are inserted into a hardware FIFO, placed into backing memory to be later read by the hardware scheduler 232, placed into a bitmap that is much larger than the 4×512 bitmap (up to and including making a single bit or multiple bits for every possible doorbell location in the doorbell bar 244) described above with respect to FIG. 6. In at least some implementations, the bitmap can be as small as a single bit for all software queues 228 in the processing system 200.

In some implementations, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A method implemented at a processing device, the method comprising:
responsive to a queue doorbell being an unmapped queue doorbell, signaling a hardware scheduler of the processing device indicating work has been placed into a queue currently unmapped to a hardware queue of the processing device.

2. The method of claim 1, further comprising:
responsive to the signaling, mapping, by the hardware scheduler, the queue to a hardware queue of a plurality of hardware queues at the processing device.

3. The method of claim 1, further comprising:
responsive to a hardware queue mapping list indicating the queue is an unmapped queue, determining the queue doorbell is an unmapped queue doorbell; and
responsive to the queue doorbell being a mapped queue doorbell, passing the queue doorbell to a command processor of the processing device.

4. The method of claim 1, further comprising:
responsive to the unmapped queue doorbell, updating a mapping data structure to indicate the queue has work, the mapping data structure mapping each queue of a plurality of queues to a doorbell register of a plurality of doorbell registers at the processing device.

5. The method of claim 4, wherein updating the mapping data structure comprises changing a value of at least one bit in the mapping data structure mapped to a doorbell register of the plurality of doorbell registers associated with the unmapped queue doorbell.

6. The method of claim 4, further comprising:
responsive to the signaling, determining, by the hardware scheduler, the queue has work based on:
identifying, at least one bit in the mapping data structure having a non-zero value; and
determining the at least one bit is mapped to the queue.

7. The method of claim 4, further comprising:
responsive to the signaling, determining, by the hardware scheduler, the queue has work based on:
responsive to a subset of queues from the plurality of queues being mapped to at least one bit having a non-zero value in the mapping data structure, processing the subset of queues; and
responsive to processing the subset of queues, determining the queue has work.

8. A processing device comprising:
a hardware scheduler; and
an unmapped queue unit configured to:
responsive to a queue doorbell being an unmapped queue doorbell, transmit a signal to the hardware scheduler indicating work has been placed into a queue currently unmapped to a hardware queue of the processing device.

9. The processing device of claim 8, wherein the hardware scheduler is configured to:
responsive to the signal, map the queue to a hardware queue of a plurality of hardware queues at the processing device.

10. The processing device of claim 9, further comprising:
a plurality of compute units; and
a command processor configured to, responsive to the hardware scheduler mapping the queue to the hardware queue, dispatch the work to one or more compute units of the plurality of compute units.

11. The processing device of claim 8, wherein the unmapped queue doorbell is generated in response to a device driver placing work in the queue.

12. The processing device of claim 11, wherein the unmapped queue doorbell is generated by writing to a doorbell register mapped to the queue.

13. The processing device of claim 8, wherein the unmapped queue unit is further configured to:
responsive to a hardware queue mapping list indicating the queue is an unmapped queue, determine the queue doorbell is an unmapped queue doorbell.

14. The processing device of claim 8, wherein the unmapped queue unit is further configured to:
responsive to the queue doorbell being a mapped queue doorbell, passing the queue doorbell to a command processor of the processing device.

15. The processing device of claim 8, wherein the unmapped queue unit is further configured to:
responsive to the unmapped queue doorbell, update a mapping data structure to indicate the queue has work, the mapping data structure mapping each queue of a plurality of queues to a doorbell register of a plurality of doorbell registers at the processing device.

16. The processing device of claim 15, wherein the unmapped queue unit is configured to update the mapping data structure by changing a value of at least one bit in the mapping data structure mapped to a doorbell register of the plurality of doorbell registers associated with the unmapped queue doorbell.

17. The processing device of claim 15, wherein the hardware scheduler is configured to:
responsive to the signal, determine the queue has work based on:
identifying, at least one bit in the mapping data structure having a non-zero value; and
determining the at least one bit is mapped to the queue.

18. The processing device of claim 15, wherein the hardware scheduler is configured to:
responsive to the signal, determine the queue has work based on:
responsive to a subset of queues from the plurality of queues being mapped to at least one bit having a non-zero value in the mapping data structure, processing the subset of queues; and
responsive to processing the subset of queues, determining the queue has work.

19. The processing device of claim 15, the unmapped queue unit is further configured to:
responsive to transmitting the signal to the hardware scheduler, pause additional signals from being transmitted to the hardware scheduler when additional unmapped queue doorbells for the queue are detected until the hardware scheduler processes the transmitted signal.

20. A processing device comprising:
a hardware scheduler;
a mapping data structure comprising a plurality of register arrays, wherein each register array of the plurality of register arrays comprises a plurality of bits mapped to a different set of queue doorbells; and
an unmapped queue unit configured to:
detect an unmapped queue doorbell associated with a queue currently unmapped to a hardware queue of the processing device;
responsive to the detected unmapped queue doorbell, update at least one bit mapped to the unmapped queue doorbell in a register array of the plurality of register arrays; and
send a signal indicating to the hardware scheduler to process the mapping data structure,
wherein the hardware scheduler is configured to:
responsive to the signal, determine the queue has work based on the updated at least one bit; and
map the queue to a hardware queue of the processing device.
